(19) United States
(12) Patent Application Publication
(10) Pub. No.: US 2022/0407554 A1
(43) Pub. Date: Dec. 22, 2022

(54) Cell Phone Charging Case Device

(71) Applicant: Jacob Lebaron, Winnfield, LA (US)

(72) Inventor: Jacob Lebaron, Winnfield, LA (US)

(21) Appl. No.: 17/671,884

(22) Filed: Feb. 15, 2022

Related U.S. Application Data
(60) Provisional application No. 63/211,460, filed on Jun. 16, 2021.

(51) Int. Cl. H04B 1/3883; H04B 1/3888; H04M 1/04; H02J 7/00

(52) U.S. Cl. CPC H04B 1/3883; H04B 1/3888; H04M 1/04; H02J 7/0044

(57) ABSTRACT

The present invention relates generally to the field of cell phone cases. More specifically, the present invention relates to a cell phone charging case device that is comprised of a body, a rear surface, a storage compartment, a cover and at least one charging cable. The device is also comprised of a detachable storage compartment that is further comprised of a battery and at least one charging cable that may charge external devices other than the cell phone it encases. Thus, the device can be applied to any cell phone, such that a cell phone may be charged without the need for an electrical wall outlet.

### CROSS-REFERENCE TO RELATED APPLICATION

The present application claims priority to, and the benefit of, U.S. Provisional Application No. 63/211,460, which was filed on Jun. 16, 2021 and is incorporated herein by reference in its entirety.

### FIELD OF THE INVENTION

The present invention relates generally to the field of cell phone cases. More specifically, the present invention relates to a cell phone charging case device that is comprised of a body, a rear surface, a storage compartment, a cover and at least one charging cable. The device is also comprised of a detachable storage compartment that is further comprised of a battery and at least one charging cable that may charge external devices different from the cell phone it encases. In this manner, the device can be applied to any cell phone, such that a cell phone may be charged without the need for an electrical wall outlet. Accordingly, the present disclosure makes specific reference thereto. Nonetheless, it is to be appreciated that aspects of the present invention are also equally applicable to other like applications, devices and methods of manufacture.

### BACKGROUND

In the modern world, a cell phone is a completely necessary device for people of all ages. It can be used to keep children occupied on long car rides, answer work emails, catch up with friends not seen in some time and/or to surf the web on one of the many social media apps. While all these applications are useful, they can drain a cell phone's battery quickly. If a cell phone's battery dies, it is possible not only to miss out on the enjoyment of the cell phone, but also on emergency phone calls, work deadlines and other time-sensitive information. Further, charging cables can be a hassle to deal with, as they can act as tripping hazards if left out in the open or can become tangled. For those on-the-go, it is especially important to have a fully charged cell phone battery, without having to carry a long charging cable with them everywhere they go.

Therefore, there exists a long-felt need in the art for an improved cell phone charging case device. There also exists a long-felt need in the art for a cell phone charging case device that allows the user to charge a cell phone free of a charging port, wall outlet or other restraint while charging his or her cell phone. Further, there exists a long-felt need in the art for a cell phone charging case device capable of interfacing with any cell phone known in the art. In addition, there exists a long-felt need in the art for an improved cell phone charging case device capable of charging multiple devices simultaneously, while still providing protection for a cell phone.

The subject matter disclosed and claimed herein, in one embodiment thereof, comprises a cell phone charging case device. The device is comprised of a body, a rear surface, a storage compartment, a cover and at least one charging cable. The body of the device preferably resembles a cell phone case and is flexible or semi-flexible, such that it can conform to different styles of cell phones known in the art. The device is also comprised of a detachable storage compartment that is further comprised of a battery and at least one charging cable, that may charge other external devices besides the cell phone it encases. In this manner, the device can be applied to any cell phone, such that a cell phone may be charged without the need for an electrical wall outlet.

In this manner, the cell phone charging case device of the present invention accomplishes all the forgoing objectives and provides an improved means for charging a cell phone independent of an electrical wall outlet. Further, the device acts as a protective case that integrates with any conventional cell phone known in art, while simultaneously charging the cell phone. In addition, the device contains at least one charging cable in a detachable compartment, to charge at least one external device, such as a tablet or second cell phone.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a cell phone charging case device that protects a cell phone, while simultaneously charging the cell phone and/or other devices. The device is primarily comprised of a body, a rear surface, a storage compartment, a cover and at least one charging cable. In differing embodiments, the body may have the appearance of a plurality of differing types of cell phone cases, to fit a plurality of differing types of cell phones. The device may also be made of a plurality of materials commonly used in cell phone cases or protective casings. However, the body is preferably made of a flexible or semi-flexible plastic material that is waterproof. In addition, any surface of the body may be comprised of a plurality of indicia, such as patterns, logos, emblems, images, symbols, designs, letters, words, characters, animals, advertisements, brands, etc., that may or may not be phone-related.

The device integrates with a cell phone, such that any feature of the cell phone is not obstructed by the device. The body of the device also has at least one continuous opening on its rear surface, and at least one continuous opening on its side surface, that allow the camera and other buttons, such as power and volume buttons, to remain operable when the device is in use. Further, the rear surface of the body attaches to a storage compartment. These features may attach to each other, preferably using magnets, or they may attach in a variety of other attachment methods, such as adhesives and snap-fit, as long as the storage compartment may be completely separated from the body of the device.

The storage compartment is further comprised of an interior surface in which at least one groove is inlaid, to accept at least one charging cable. The grooves provide the cables with an area to be stored, such that it prevents the cables from moving or becoming tangled. The charging cables of the device may be different types of cables, to accommodate different types of charging ports on devices that may need charged. In addition, the storage compartment houses an internal battery that may be disposable, but in the preferred embodiment is rechargeable via a USB port. The internal battery powers the device and allows it to charge other external devices.

At least one hinge attaches a cover to the storage compartment. The bottom surface of the cover closes over the interior surface of the storage compartment. The bottom surface of the cover is typically made of a material safe for the electronics of the storage compartment. The bottom surface may also be magnetic to secure to the interior surface of the storage compartment. Both the storage compartment and the cover have cutouts in the same relative location, such that the rear camera of the cell phone remains operable and unobstructed. The top surface of the cover is the outermost protective layer of the device and may also be magnetic, to allow for the attachment of external gadgets, such as a magnetic wallet.

Accordingly, the cell phone charging case device of the present invention is particularly advantageous as it provides a means to charge a cell phone independent of an electrical wall outlet. Further, the device can charge multiple external devices, other than just the phone it encases, using at least one charging cable in a detachable compartment. In addition, the device acts as a protective case for any conventional cell phone known in the art, while simultaneously charging the cell phone.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the cell phone charging case device of the present invention in an opened and unattached manner in accordance with the disclosed architecture;

FIG. 2 illustrates a perspective view of one potential embodiment of the cell phone charging case device of the present invention in accordance with the disclosed architecture;

FIG. 3 illustrates an enhanced perspective view of the charging cables of one potential embodiment of the cell phone charging case device of the present invention in accordance with the disclosed architecture;

FIG. 4 illustrates a perspective view of one potential embodiment of the cell phone charging case device of the present invention in an attached and closed manner in accordance with the disclosed architecture; and

FIG. 5 illustrates a perspective view of one potential embodiment of the cell phone charging case device of the present invention in use in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention, and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved cell phone charging case device. There also exists a long-felt need in the art for a cell phone charging device that allows the user to use a cell phone while it is charging without being restricted by charging cables, ports and other restraints. Further, there exists a long-felt need in the art for a cell phone charging case device that may provide protection to a cell phone while it is being charged. In addition, there exists a long-felt need in the art for a charging device capable of charging multiple different devices simultaneously.

The present invention, in one exemplary embodiment, is comprised of a cell phone charging case device that protects a cell phone while simultaneously charging the cell phone and/or other devices. The device is primarily comprised of a body, a rear surface, a storage compartment, a cover and at least one charging cable. In differing embodiments, the body may have the appearance of a plurality of differing types of cell phone cases to fit a plurality of differing types of cell phones. The device may also be made of a plurality of materials, such as a metal or wood, but is preferably made of a flexible or semi-flexible plastic material and is waterproof. In addition, any surface of the body may be comprised of a plurality of indicia, such as patterns, logos, emblems, images, symbols, designs, letters, words, characters, animals, advertisements, brands, etc., that may or may not be phone-related.

Further, the device integrates with the back of a cell phone, such that the phone's screen is not covered and is completely visible. The body has at least one continuous opening that allows a rear camera of a phone to still be used. The body is further comprised of a side surface and rear surface. The side surface of the device protects the sides of the cell phone and contains at least one continuous opening to allow for the user to press buttons that commonly appear on the sides of cell phones. A storage compartment of the device is removably-attached to the rear surface so that it may charge external components, such as a second cell phone or a tablet.

The storage compartment is comprised of an interior surface in which at least one groove may be etched that receives at least one charging cable to guide and keep in place. In addition, the storage compartment has a cutout and an internal battery to power the charging device. In differing embodiments, the internal battery may be disposable, but in the preferred embodiment the internal battery is rechargeable via a USB port on a surface of the storage compartment. The components of the storage compartment are protected by a cover. At least one hinge attaches the cover to the storage compartment. Similar to the storage compartment, the cover has a cutout. Both cutouts of the device are of the same size and lie where the device would cover a rear camera of a cell phone. The bottom surface of the cover closes into the storage compartment and is preferably made of a material that does not interfere with the electrical capabilities of a charging cable. The top surface of the cover is the outer protective side of the device and its many internal components. Both the top and bottom surfaces of the cover may be magnetic, such that the cover remains secured to the storage compartment and external gadgets, such as a magnetic wallet, may be attached to the top surface of the device.

Accordingly, the cell phone charging case device of the present invention is particularly advantageous as it provides a means to charge a cell phone independently of an electrical wall outlet. Further, the device protects any conventional cell phone known in the art, as it acts as a protective casing for the phone while simultaneously charging it. In addition, the device may charge at least one external device, such as a second cell phone or tablet, using at least one charging cable provided in a detachable compartment.

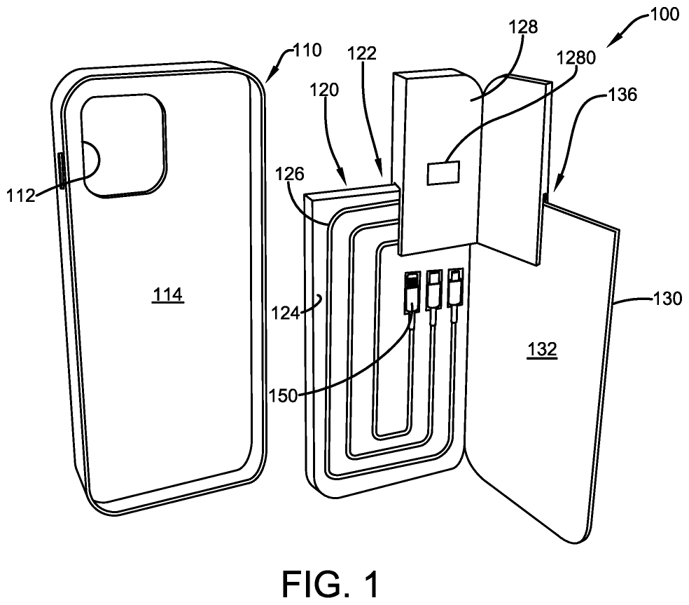

Referring initially to the drawings, FIG. 1 illustrates a perspective view of one embodiment of the cell phone charging case device 100 of the present invention in an opened and unattached manner. The device 100 is primarily comprised of a body 110, a rear surface 114, a storage compartment 120, a cover 130 and at least one charging cable 150. In differing embodiments, the body 110 may have the appearance of a plurality of differing types of conventional cell phone cases to fit any conventional cell phone 10 known in the art. All components of the device 100 may be made of a flexible or semi-flexible plastic, such as but not limited to, acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, etc., a durable metal, such as stainless steel, aluminum, carbon fiber, etc., or any other suitable material as is known in the art. In addition, the device 100 is sealed to keep its internal components, as well as the cell phone 10, water resistant and the device 100 may be transparent, semi-transparent or opaque in differing embodiments. Furthermore, any surface 114, 124, 132, 138, 140 of the device 100 may be comprised of any number of indicia in the form of patterns, logos, emblems, images, symbols, designs, letters, words, characters, animals, advertisements, brands, etc.

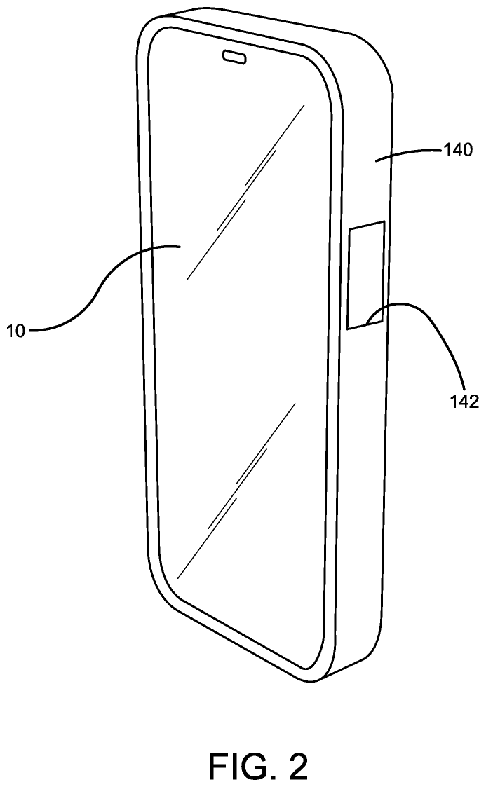

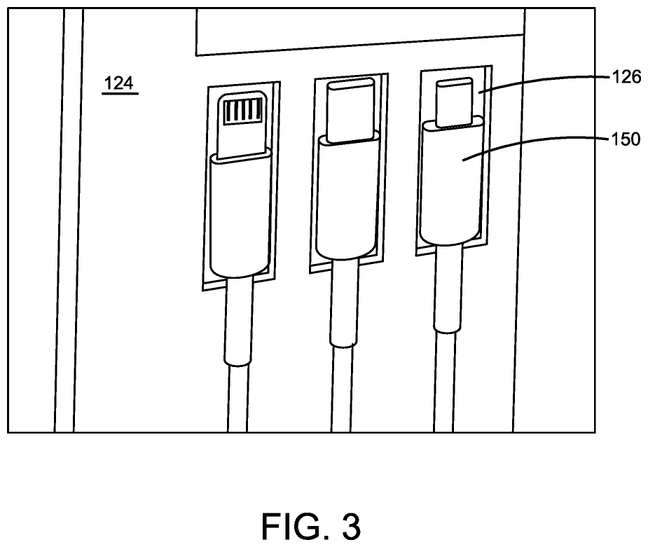

In the preferred embodiment of the device 100 shown in FIGS. 1-3, the body 110 resembles a conventional cell phone case known in the art used for preventing a conventional cell phone 10 from becoming damaged. The body 110 has at least one continuous opening 112 at its rear surface 114 and at least one continuous opening 142 on its side surface 140 (as best seen in FIG. 2), such that the cell phone's rear camera and other buttons, such as power and volume buttons, may still be exposed and operable. The rear surface 114 of the body 110 then attaches to a storage compartment 120 in which the charging capabilities of the device 100 are contained. The storage compartment 120, which may attach to the rear surface 114 of the body 110 using a plurality of removable attachment methods, such as but not limited to: a snap fit, a press fit, an adhesive, etc., but is preferably attached using magnets, or any other suitable attachment means as is known in the art. Specifically, the rear surface 114 and storage compartment 120 may be manufactured from magnetic materials, or there may be magnets contained in the surfaces in some other means to connect the rear surface 114 and compartment 120. In addition, the storage compartment 120 is comprised of at least one groove 126 on the interior surface 124, that receives at least one charging cable 150 and keeps the cable 150 from moving while in the compartment 120 (as best seen in FIG. 3). The interior surface 124 may be made of a material that is not damaging to electronics, such as but not limited to, velvet, a soft fabric, or other suitable soft material or plastic as is known in the art.

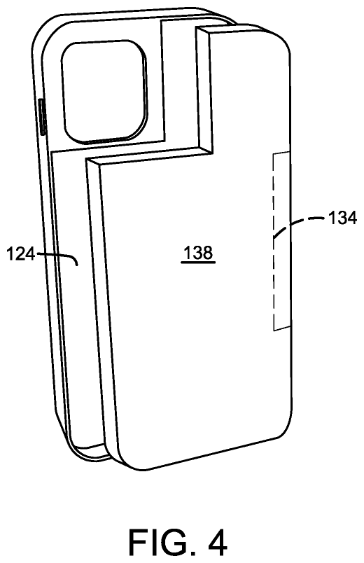

FIG. 4 illustrates a perspective view of one embodiment of the cell phone charging case device 100 of the present invention in an attached and closed manner. The storage compartment 120 is also protected by a cover 130 (shown in FIG. 1). The cover 130 connects to the storage compartment 120 by at least one hinge 134, such that the cover 130 may easily opened for access to at least one charging cable 150. In differing embodiments, the at least one hinge 134 may be any suitable hinge type known in the art, such as but not limited to: an offset blind hinge, a knuckle hinge, a butt hinge, a rising butt hinge, a gravity pivot hinge, a ball bearing hinge, a barrel hinge, a concealed hinge, a knife hinge, a piano hinge, a strap hinge, a pivot hinge, a gas-piston hinge, an injection molded hinge, a locking hinge, etc. Further, the bottom surface 132 of the cover 130 may made of a material that is not damaging to electronics, such as but not limited to, velvet, a soft fabric or any other suitable soft material or plastic as is known in the art. In addition, the bottom surface 132 may be magnetic to protect and secure the storage compartment 120 and remain attached to the compartment 120 while still being accessible. The top surface 138 of the cover 130 is the outermost layer of the back of the device 100 and protects the cell phone 10, as well as the components of the storage compartment 120, if dropped or impacted by other objects. The top surface 138 may also be magnetic in differing embodiments to allow common magnetic cell phone attachments known in the art, such as but not limited to, a magnetic wallet, etc., to attach. Both the storage compartment 120 and the cover 130 have a cutout 122, 136 that line up with each other, as well as the rear camera of the cell phone 10, such that the camera may be operable (i.e. not obstructed by the device 100) when the device 100 is in use.

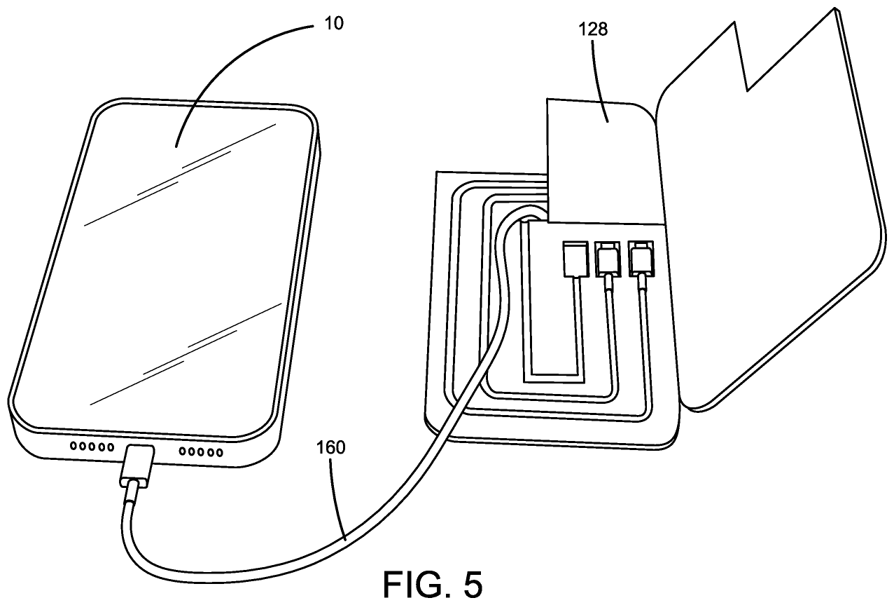

FIG. 5 illustrates a perspective view of one embodiment of the cell phone charging case device 100 of the present invention in use. The storage compartment 120 of the device 100 is additionally comprised of an internal battery 128. The internal battery 128 may be a disposable battery 128 or a rechargeable battery 128 in the form of an alkaline, nickel-cadmium, nickel-metal hydride battery 128, etc., such as any 3V-12 volt DC battery 128 or other conventional battery 128 known in the art, such as A, AA, AAA, etc., that supplies power to the device. Throughout this specification, the term “battery” may be used interchangeably to refer to one or more wet or dry cells or batteries 128 of cells in which chemical energy is converted into electricity and used as a source of DC power. References to recharging or replacing the battery 128 may refer to recharging or replacing individual cells, individual batteries 128 of cells or a package of multiple battery 128 cells as is appropriate for any given battery 128 technology that may be used. In the embodiment of a disposable battery 128, the battery 128 compartment may contain a hinge and snap-fit mechanism to easily access and replace the battery 128. In the embodiment of a rechargeable battery 128, a USB port 1280 (shown in FIG. 1) may be used to recharge the battery 128. The USB port 1280 may be USB-A, USB-B, Micro-B, Micro-USB, Mini-USB, USB-C, etc., in differing embodiments. The USB port 1280 may also receive the charging cable 150, such that the battery 128 provides power to the cable 150 in order to allow the cable to charge a cell phone 10. In differing embodiments, the cable 150 may be of any charging cable type known in the art, to allow a user to charge any cell phone 10 known in the art.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “cell phone charging case device” and “device” are interchangeable and refer to the cell phone charging case device 100 of the present invention.

Notwithstanding the forgoing, the cell phone charging case device 100 of the present invention and its various components can be of any suitable size and configuration as is known in the art without affecting the overall concept of the invention, provided that they accomplish the above-stated objectives. One of ordinary skill in the art will appreciate that the size, configuration and material of the cell phone charging case device 100 as shown in FIGS. 1-5 is for illustrative purposes only, and that many other sizes and shapes of the cell phone charging case device 100 are well within the scope of the present disclosure. Although the dimensions of the cell phone charging case device 100 are important design parameters for user convenience, the cell phone charging case device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cell phone charging case device comprising:
a body that can be secured to a cell phone comprising opposing side surfaces and a rear surface;
wherein the body integrates with a back of the cell phone, such that a cell phone's screen is not covered and visible;
wherein the rear surface comprises at least one continuous opening that allows a rear camera of the cell phone to be visible;
wherein the opposing side surfaces comprise at least one continuous opening that allows at least one button of the cell phone to be visible;
a storage compartment secured to the rear surface for storing at least one charging cable; and
a cover which secures the storage compartment, wherein the storage compartment contains charging capabilities.

2. The cell phone charging case device of claim 1, wherein the storage compartment comprises at least one least one groove on an interior surface, that receives the at least one charging cable and keeps the at least one charging cable from moving while in the storage compartment.

3. The cell phone charging case device of claim 2, wherein the at least one charging cable receives power from an internal battery positioned within the storage compartment.

4. The cell phone charging case device of claim 3, wherein the at least one charging cable is used to charge an external cell phone.

5. A cell phone charging case device comprising:
a body that can be secured to a cell phone comprising opposing side surfaces and a rear surface;
wherein the body integrates with a back of the cell phone, such that a cell phone's screen is not covered and visible;
wherein the rear surface comprises at least one continuous opening that allows a rear camera of the cell phone to be visible;
wherein the opposing side surfaces comprise at least one continuous opening that allows at least one button of the cell phone to be visible;
a storage compartment secured to the rear surface for storing at least one charging cable, wherein the storage compartment comprises at least one groove on an interior surface, that receives the at least one charging cable and keeps the at least one charging cable from moving while in the storage compartment;
an internal battery which provides power to the at least one charging cable and a USB port positioned within the storage compartment for charging the cell phone and for charging external devices; and
a cover which protects and secures the storage compartment, wherein the storage compartment contains charging capabilities of the cell phone charging case device.

6. The cell phone charging case device of claim 5, wherein the cover connects to the storage compartment by at least one hinge.

7. The cell phone charging case device of claim 6, wherein a top surface of the storage compartment and cover is magnetic to allow a magnetic wallet to attach.

8. The cell phone charging case device of claim 7, wherein the storage compartment and the cover are further comprised of a cutout, such that the storage compartment and the cover allow a rear camera of the cell phone to be visible.

9. A cell phone charging case device comprising:
a body that can be secured to a cell phone comprising opposing side surfaces and a rear surface;
wherein the body integrates with a back of the cell phone, such that a cell phone's screen is not covered and visible;
wherein the rear surface comprises at least one continuous opening that allows a rear camera of the cell phone to be visible;
wherein the opposing side surfaces comprise at least one continuous opening that allows at least one button of the cell phone to be visible;
a storage compartment secured to the rear surface for storing at least one charging cable, wherein the storage compartment comprises at least one groove on an interior surface, that receives the at least one charging cable and keeps the at least one charging cable from moving while in the storage compartment;
an internal battery which provides power to the at least one charging cable and a USB port positioned within the storage compartment for charging the cell phone and for charging external devices; and
a cover which protects and secures the storage compartment, wherein the storage compartment and the cover are further comprised of a cutout, such that the storage compartment and the cover allow a rear camera of the cell phone to be visible, and further wherein the storage compartment contains charging capabilities.

10. The cell phone charging case device of claim 9, wherein the rear surface and the storage compartment are manufactured of a magnetic material, such that the rear surface and the storage compartment magnetically attach to one another.

11. The cell phone charging case device of claim 9, wherein the rear surface and the storage compartment are attached to one another via a press fit attachment.

12. The cell phone charging case device of claim 9, wherein the rear surface and the storage compartment are attached to one another via an adhesive.

13. The cell phone charging case device of claim 9, wherein the cover connects to the storage compartment by at least one hinge.

14. The cell phone charging case device of claim 9, wherein a top surface of the cover protects the cell phone and protects the storage compartment if dropped or impacted by an object.

15. The cell phone charging case device of claim 9, wherein a top surface of the storage compartment and cover is magnetic to allow a magnetic wallet to attach.

16. The cell phone charging case device of claim 9, wherein the USB port is a USB-A, a USB-B, a Micro-B, a Micro-USB, a Mini-USB, or a USB-C port.

17. The cell phone charging case device of claim 16, wherein the USB port receives the at least one charging cable.

18. The cell phone charging case device of claim 17, wherein the USB port recharges the internal battery.

19. The cell phone charging case device of claim 9, wherein at least one surface of the cell phone charging case device may be comprised of a plurality of indicia.

20. The cell phone charging case device of claim 19, wherein the plurality of indicia comprises at least one of a pattern, a logo, an emblem, an image, a symbol, a design, a letter, a word, a character, an animal, an advertisement, or a brand.
